(19) United States
(12) Patent Application Publication
(10) Pub. No.: US 2011/0081284 A1
(43) Pub. Date: Apr. 7, 2011

(54) TREATMENT OF BAUXITE RESIDUE AND SPENT POT LINING

(76) Inventors: Mark WEAVER, Greenwell Springs, LA (US); David ROHA, Greensburg, PA (US); Gerald CARKIN, Tarentum, PA (US)

(21) Appl. No.: 12/572,712

(22) Filed: Oct. 2, 2009

(51) Int. Cl. C01G 49/00; C01B 31/20; C01B 33/12

(52) U.S. Cl. 423/138; 252/372; 423/335

(57) ABSTRACT

Methods of treating spent pot lining (SPL) and bauxite residue are disclosed. The treatment processes are capable of producing a ferrosilicon alloy, an off-gas, and/or a byproduct material resulting in the safe disposal of SPL and bauxite residue. The treatment processes may be continuously carried out in an electric arc furnace at a temperature in the range of from about 1500° C. to about 2200° C. and for a period of from about 15 to about 100 minutes.

### BACKGROUND

Aluminum smelting produces tons of waste products including spent pot lining and bauxite residues each year. Significant challenges remain in finding successful and economic ways of disposing of these waste products.

### SUMMARY

Methods of treating bauxite residue and spent pot lining, and producing ferrosilicon alloys, off-gases, and/or byproduct materials resulting therefrom are disclosed.

One embodiment discloses a method of treating waste products by producing a mixture having spent pot lining and bauxite residue, heating the mixture at a temperature of at least about 1500° C., and producing at least one of a ferrosilicon alloy, an off-gas, and a byproduct material from the mixture and due, at least in part, to the heating step.

In one embodiment, the spent pot lining includes cyanide and fluoride and the bauxite residue includes iron oxide and silicon dioxide. In one embodiment, the method may be capable of converting at least a portion of the cyanide into a non-toxic component and vaporizing at least a portion of the fluoride. In another embodiment, the method may be capable of converting at least a portion of the silicon dioxide into a silicon portion of the ferrosilicon alloy, converting at least a portion of the iron oxide into an iron portion of the ferrosilicon alloy, and converting at least a portion of the fluoride into a portion of at least one of the off-gas and the byproduct materials.

In one embodiment, the method further includes cooling the off-gas and producing, concomitant to the cooling step, a powder product, wherein the powder product includes at least one of metal oxide and metal fluoride. In another embodiment, the method further includes recycling the powder product to an aluminum smelter. In yet another embodiment, the method further includes producing, concomitant to the cooling step, a recyclable gas, wherein the recyclable gas includes at least one of carbon monoxide and fluoride gas.

In one embodiment, the mixture further includes a silicon additive, whereby concomitant to the heating step, the method includes converting at least a portion of the silicon additive into a silicon portion of the ferrosilicon alloy. In another embodiment, the mixture further includes a calcium additive, whereby concomitant to the heating step, the method includes converting at least a portion of the calcium additive into a portion of the at least one of the off-gas and the byproduct material.

In one embodiment, the mixture may be heated at a temperature in the range of from about 1500° C. to about 2200° C. and for a period of from about 15 to about 100 minutes. In another embodiment, the mixture may include agglomerating of the spent pot lining and the bauxite residue into a cluster. In these instances, the agglomerating step includes mixing a binder with the spent pot lining and the bauxite residue, wherein the binder comprises at least one of organic compounds and inorganic materials.

The methods described above may be used to produce ferrosilicon alloys, off-gases, and/or byproduct materials. Several aspects of the disclosure are the production of each of these materials using the methods described herein.

In one embodiment, a ferrosilicon alloy having at least 10 wt. % silicon may be produced by heating a mixture of spent pot lining and bauxite residue, wherein the bauxite residue comprises iron oxide and silicon dioxide, and concomitant to the heating step, producing the ferrosilicon alloy, wherein the producing step includes at least one of converting at least a portion of the silicon dioxide into a silicon portion of the ferrosilicon alloy or converting at least a portion of the iron oxide into an iron portion of the ferrosilicon alloy. In another embodiment, the mixture further includes a silicon additive, and wherein at least a portion of the silicon additive may be converted into a silicon portion of the ferrosilicon alloy and due, at least in part, to the heating step. Like above, the heating of the mixture can be carried out at a temperature of at least about 1500° C.

In one embodiment, a recyclable gas having at least one of carbon monoxide and fluoride gas may be produced by heating a mixture of spent pot lining and bauxite residue, wherein the spent pot lining comprises fluoride, concomitant to the heating step, converting at least a portion of the fluoride into a portion of an off-gas, and cooling the off-gas. Like above, the heating of the mixture can be carried out at a temperature of at least about 1500° C.

In one embodiment, a byproduct material having at least one of silicon dioxide and aluminum oxide may be produced by heating a mixture of spent pot lining and bauxite residue, wherein the spent pot lining includes fluoride and wherein the bauxite residue includes iron oxide and silicon dioxide, and concomitant to the heating step, producing the byproduct material, wherein the producing step includes at least one of converting at least a portion of the fluoride into a first portion of the byproduct material, converting at least a portion of the silicon dioxide into a second portion of byproduct material, or converting at least a portion of the iron oxide into a third portion of the byproduct material. Like above, the heating of the mixture can be carried out at a temperature of at least about 1500° C.

Other variations, embodiments and features of the present disclosure will become evident from the following detailed description, drawings and claims.

### BRIEF DESCRIPTION OF THE DRAWINGS

FIG. 1 is a block diagram illustrating a process flow of treating spent pot lining (SPL) and bauxite residue according to one embodiment of the present disclosure;

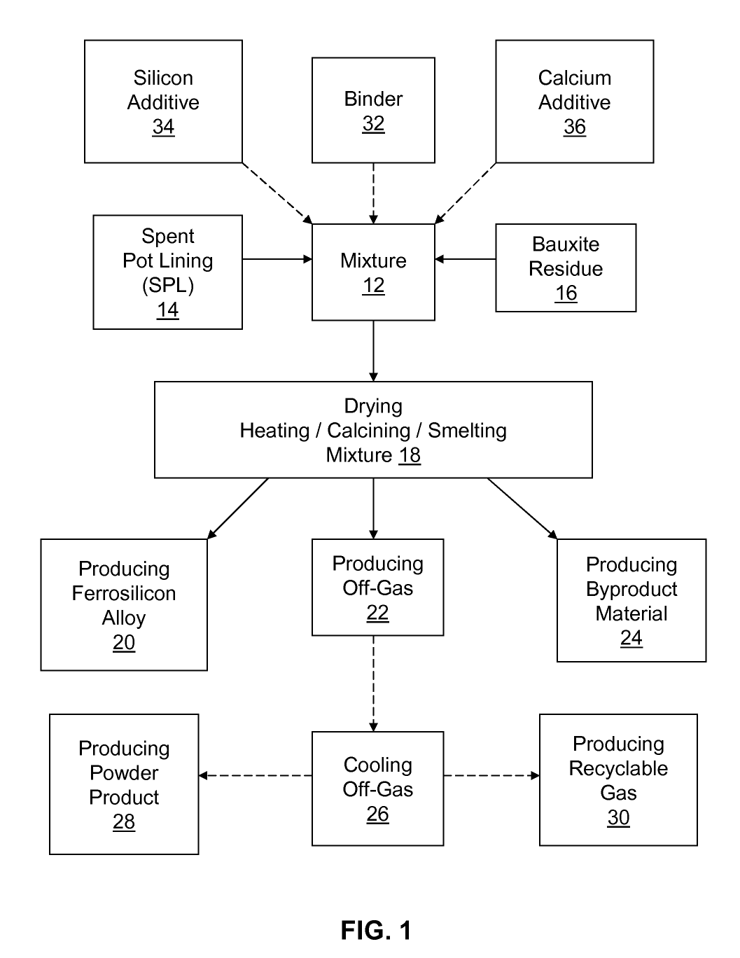

FIG. 2 is a block diagram illustrating a process flow of treating SPL and bauxite residue with a binder according to one embodiment of the present disclosure;

FIG. 3 is a block diagram illustrating a process flow of treating SPL and bauxite residue (average) with the a binder according to one embodiment of the present disclosure;

FIG. 4 is a block diagram illustrating a process flow of treating SPL and bauxite residue (average) with silicon dioxide according to one embodiment of the present disclosure; and

FIG. 5 is a block diagram illustrating a process flow of treating SPL and bauxite residue (average) with silicon dioxide and calcium carbonate according to one embodiment of the present disclosure.

### DETAILED DESCRIPTION

It will be appreciated by those of ordinary skill in the art that the disclosure can be embodied in other specific forms without departing from the spirit or essential character thereof. The presently disclosed embodiments are therefore considered in all respects to be illustrative and not restrictive.

Broadly, the present disclosure relates to methods of treating spent pot lining (SPL) and bauxite residue, and producing ferrosilicon alloys, off-gases, and/or byproduct materials resulting therefrom. One method of treating SPL and bauxite residue includes producing a mixture 12 containing SPL 14 and bauxite residue 16. The mixture 12 may then be heated at a temperature of at least about 1500° C. In one embodiment, the SPL 14 includes cyanide and fluoride. In one embodiment, the bauxite residue 16 includes iron oxide and silicon dioxide. In another embodiment, the SPL 14 contains carbon and refractory materials and the bauxite residue 16 contains aluminum oxide.

In one embodiment, due in part to the heating step 18, at least a portion of the cyanide may be converted to a non-toxic component and at least a portion of the fluoride may be vaporized. In another embodiment, the cyanide may be thermally destroyed. In another embodiment, at least due in part to the heating step 18, at least one of a ferrosilicon alloy 20, an off-gas 22, and a byproduct material 24 may be produced. In one embodiment, the at least one of the ferrosilicon alloy 20, the off-gas 22, and the byproduct material 24 may be produced by: (i) converting at least a portion of the silicon dioxide into a silicon portion of the ferrosilicon alloy 20; (ii) converting at least a portion of the iron oxide into an iron portion of the ferrosilicon alloy 20; and (iii) converting at least a portion of the fluoride into a portion of the at least one of the off-gas 22 and the byproduct material 24. In another embodiment, the mixture 12 of SPL 14 and the bauxite residue 16 may be reduced during the heating step 18 to produce the at least of the ferrosilicon alloy 20, the off-gas 22, and the byproduct material 24.

As used herein, “ferrosilicon alloy” 20 and the like means an alloy containing iron and silicon with silicon contents in the range of from about 10 wt. % to about 90 wt. %. In one embodiment, the ferrosilicon alloy 20 may consist essentially of not greater than about 90 wt. % iron and correspondingly, not greater than about 10 wt. % silicon, balanced by impurities (e.g., aluminum, carbon). In one embodiment, the ferrosilicon alloy 20 may consist essentially of not greater than about 55 wt. % iron and correspondingly, not greater than about 45 wt. % silicon, balanced by impurities. In one embodiment, the ferrosilicon alloy 20 may consist essentially of not greater than about 10 wt. % iron and correspondingly, not greater than about 90 wt. % silicon, balanced by impurities. In some embodiments, the ferrosilicon alloy 20 may contain not greater than about 10 wt. % silicon, not greater than about 15 wt. % silicon, or not greater than about 45 wt. % silicon, or not greater than about 75 wt. % silicon, or not greater than about 90 wt. % silicon, balanced by iron and impurities (e.g., aluminum, carbon). In some embodiments, the ferrosilicon alloy 20 may contain up to about 6 wt. % impurities, such as up to about 2 wt. % or up to about 3 wt. % each of aluminum and carbon, among other impurities. In other embodiments, the ferrosilicon alloy 20 may include other impurities such as calcium, sodium, and titanium, among others.

In some embodiments, the ferrosilicon alloy 20 may contain silicon in the range of from about 10 wt. % to about 15 wt. %, or in the range of from about 15 wt. % to about 45 wt. %, or in the range of from about 45 wt. % to about 75 wt. %, or in the range of from about 75 wt. % to about 90 wt. %. In some embodiments, the ferrosilicon alloy 20 includes at least about 15 wt. % silicon, or at least about 45 wt. % silicon, or at least about 75 wt. % silicon, or at least about 90 wt. % silicon. In some embodiments, the ferrosilicon alloy 20 includes not greater than about 90 wt. % silicon, or not greater than about 75 wt. % silicon, or not greater than about 45 wt. % silicon, or not greater than about 15 wt. % silicon, or not greater than about 10 wt. % silicon.

In some embodiments, the ferrosilicon alloy 20 may contain iron in the range of from about 10 wt. % to about 25 wt. %, or in the range of from about 25 wt. % to about 55 wt. %, or in the range of from about 55 wt. % to about 85 wt. %. In some embodiments, the ferrosilicon alloy 20 includes at least about 10 wt. % iron, or at least about 25 wt. % iron, or at least about 55 wt. % iron, or at least about 85 wt. % iron. In some embodiments, the ferrosilicon alloy 20 includes not greater than about 85 wt. % iron, or not greater than about 55 wt. % iron, or not greater than about 25 wt. % iron, or not greater than about 10 wt. % iron.

In one embodiment, the ferrosilicon alloy 20 contains at least about 80 wt. % iron, at least about 14.5 wt. % silicon, at least about 2.75 wt. % aluminum, and at least about 2.75 wt. % carbon, among other impurities. In one embodiment, the ferrosilicon alloy 20 contains at least about 66.7 wt. % iron and at least about 33.3 wt. % silicon, among other impurities. In one embodiment, the ferrosilicon alloy 20 contains at least about 54.5 wt. % iron, at least about 45.3 wt. % silicon, and at least about 0.2 wt. % aluminum, among other impurities. In one embodiment, the ferrosilicon alloy 20 contains at least about 54.1 wt. % iron, at least about 45.2 wt. % silicon, at least about 0.4 wt. % aluminum, and at least about 0.2 wt. % carbon, among other impurities.

As used herein, “off-gas” 22 and the like means gas or vapor given off or expelled as a result of a treatment process. In one embodiment, the off-gas 22 includes vaporized particles comprising at least two substances. For example, when a mixture 12 comprising SPL 14 and bauxite residue 16 is heated, a fluoride-containing gas (e.g., containing NaF and/or CaF) may be produced. In one embodiment, the off-gas 22 includes vaporized forms of metal oxides and metal fluorides, among others. In one embodiment, the off-gas 22 includes vaporized forms of carbon monoxide, sodium oxide, aluminum oxide, silicon dioxide, and carbon, among others. Examples of metal oxides include aluminum oxide, calcium oxide, titanium oxide, silicon oxide, silicon dioxide, sodium oxide, and iron oxide, among others. Examples of metal fluorides include aluminum fluoride, calcium fluoride, titanium fluoride, sodium fluoride, and iron fluoride, among others.

As used herein, “byproduct material” 24 and the like means substances produced from the heating of SPL 14 and/or bauxite residue 16 that are not a ferrosilicon alloy 20 or an off-gas 22. In one embodiment, the byproduct material 24 includes at least one of aluminum oxide, calcium oxide, titanium oxide, calcium fluoride, silicon dioxide, and sodium fluoride, among others. In another embodiment, the byproduct material 24 is an aggregate that can be used as a composite material. In other embodiments, the byproduct material 24 may be used as cement additives, construction fillers, glass fibers, ceramic tiles, shingles, to name a few. In some embodiments, the byproduct material 24 is a slag comprising a mixture of metal oxides, metal fluorides, metal sulfides and metal atoms in elemental form, among others. Examples of metal oxides include aluminum oxide, calcium oxide, titanium oxide, silicon oxide, silicon dioxide, sodium oxide, and iron oxide, among others. Examples of metal fluorides include aluminum fluoride, calcium fluoride, titanium fluoride, sodium fluoride, and iron fluoride, among others. Examples of metal sulfides include aluminum sulfide, calcium sulfide, titanium sulfide, silicon sulfide, sodium sulfide, and iron sulfide, among others. Examples of metal atoms in elemental form include aluminum, calcium, titanium, silicon, sodium, and iron, among others. In one embodiment, the slag byproduct material 24 is a non-hazardous material.

In one embodiment, the byproduct material 24 contains at least about 64.0 wt. % aluminum oxide, at least about 8.4 wt. % calcium oxide, at least about 12.8 wt. % titanium oxide, at least about 7.8 wt. % calcium fluoride, at least about 2.2 wt. % silicon oxide, at least about 2.6 wt. % sodium oxide, and at least about 2.2 wt. % iron oxide, among other impurities. In one embodiment, the byproduct material 24 contains at least about 53.4 wt. % aluminum oxide, at least about 18.9 wt. % calcium oxide, at least about 6.0 wt. % titanium oxide, at least about 15.9 wt. % silicon oxide, and at least about 5.8 wt. % sodium oxide, among other impurities. In one embodiment, the byproduct material 24 contains at least about 37.6 wt. % aluminum oxide, at least about 17.2 wt. % calcium oxide, at least about 3.8 wt. % titanium oxide, at least about 33.9 wt. % silicon oxide, and at least about 7.5 wt. % sodium oxide, among other impurities. In one embodiment, the byproduct material 24 contains at least about 33.3 wt. % aluminum oxide, at least about 14.0 wt. % calcium oxide, at least about 2.3 wt. % titanium oxide, at least about 15.6 wt. % calcium fluoride, at least about 26.1 wt. % silicon oxide, at least about 5.8 wt. % sodium oxide, and at least about 2.9 wt. % sodium fluoride, among other impurities.

In one embodiment, the byproduct material 24 contains at least about 95.5 wt. % aluminum oxide, not greater than about 3.0 wt. % titanium oxide, not greater than about 0.3 wt. % iron oxide, and not greater than about 1.0 wt. % silicon dioxide, among other impurities. In this example, the byproduct material 24 may have a bulk density of at least about 3.88 g/cc and an apparent porosity of at least about 1.5%. In another embodiment, the byproduct material 24 contains at least about 94.5 wt. % aluminum oxide, not greater than about 3.0 wt. % titanium oxide, not greater than about 0.3 wt. % iron oxide, and not greater than about 1.0 wt. % silicon dioxide, among other impurities. In this example, the byproduct material 24 may also have a bulk density of at least about 3.88 g/cc and an apparent porosity of at least about 1.5%.

As used herein, “heating” and the like means to increase the temperature of a material. In some instances, heating includes calcining, which means to heat a mixture to a high temperature to bring about thermal decomposition of each substance within the mixture. In some embodiments, the heating step 18 may be carried out by heating the mixture 12 at a temperature in the range of from about 1500° C. to about 2200° C., or from about 1500° C. to about 1600° C., or from about 1600° C. to about 1700° C., or from about 1700° C. to about 1800° C., or from about 1800° C. to about 1900° C., or from about 1900° C. to about 2000° C., or from about 2000° C. to about 2100° C., or from about 2100° C. to about 2200° C. In some embodiments, the heating temperature may be at least about 1500° C., or at least about 1600° C., or at least about 1700° C., or at least about 1800° C., or at least about 1900° C., or at least about 2000° C., or at least about 2100° C., or at least about 2200° C. In other embodiments, the heating temperature may be not greater than about 2150° C., or not greater than about 2050° C., or not greater than about 1950° C., or not greater than about 1850° C., or not greater than about 1750° C., or not greater than about 1650° C., or not greater than about 1550° C. In one embodiment, heating includes smelting of the mixture. In some embodiments, the smelting step can be carried out at temperatures similar to those for the heating and calcining steps.

In some embodiments, the heating step 18 may be carried out by heating the mixture 12 for a period in the range of from about 15 minutes to about 100 minutes, or from about 15 minutes to about 25 minutes, or from about 25 minutes to about 35 minutes, or from about 35 minutes to about 45 minutes, or from about 45 minutes to about 55 minutes, or from about 55 minutes to about 65 minutes, or from about 65 minutes to about 75 minutes, or from about 75 minutes to about 85 minutes, or from about 85 minutes to about 100 minutes. In some embodiments, the heating time may be at least about 15 minutes, or at least about 25 minutes, or at least about 35 minutes, or at least about 45 minutes, or at least about 55 minutes, or at least about 65 minutes, or at least about 75 minutes, or at least about 85 minutes, or at least about 95 minutes, or at least about 100 minutes. In other embodiments, the heating time may be not greater than about 100 minutes, or not greater than about 90 minutes, or not greater than about 80 minutes, or not greater than about 70 minutes, or not greater than about 60 minutes, or not greater than about 50 minutes, or not greater than about 40 minutes, or not greater than about 30 minutes, or not greater than about 20 minutes. In some instances, the mixture 12 may be dried prior to heating. In these examples, the drying process may be at low temperatures (e.g., not greater than about 300° C. for at least about 5 minutes).

In one embodiment, the heating step 18 may be carried out in at least one of the following devices: arc furnace, electric arc furnace, plasma arc furnace, vacuum arc remelting, and slag resistance furnace. In some instances, the heating step 18 may also be carried out in other suitable heating apparatus. As used herein, “electric arc furnace” is a furnace that is capable of heating charged materials by means of an electric arc.

In some embodiments, the ferrosilicon alloy 20 and the byproduct material 24 may be continuously produced within a furnace. In one instance, the ferrosilicon alloy 20 may form near the bottom of the furnace while the byproduct material 24 may form near the top of the furnace adjacent the ferrosilicon alloy 20. Drains and outlets may be incorporated in the furnace for retrieving the ferrosilicon alloy 20 out from near the bottom of the furnace, while the byproduct material 24 may be retrieved by collecting from an upper layer from the top or side openings of the furnace (e.g., retrieve the byproduct material 24 through a top opening in the furnace, tilt the furnace and drain the byproduct material 24 out of the sides of the furnace).

As used herein, “mixture” 12 and the like means a material composed of more than one chemical compound or element mixed together. In one embodiment, the mixture 12 contains SPL 14 and bauxite residue 16.

As used herein, “spent pot lining” (SPL) 14 means materials from the bottom (e.g., cathode) and/or side walls (e.g., refractory blocks) of a smelting pot that are removed during a relining and/or decommissioning of an aluminum electrolysis cell. SPL 14 may include metals, carbon and refractory materials. In some embodiments, materials that may be absorbed on the bottom and/or side walls of the smelting pot include sodium fluoride, aluminum oxide, silicon dioxide, calcium oxide, alumina silicate, anode materials, metals, fluorides, cyanides, carbon and silicon carbide, among others. In some instances, the source of carbon for the SPL 14 may come from anodes within an electrolysis cell. In some embodiments, the SPL 14 may include both a carbon fraction and a refractory fraction similar to those described in U.S. Patent Application No. 2008/0041277, filed Aug. 7, 2007, which is incorporated herein by reference.

In one embodiment, the SPL 14 contains, on average, about 31.1 wt. % carbon, about 20.5 wt. % sodium fluoride, about 38.8 wt. % aluminum oxide, about 6.5 wt. % silicon dioxide, and about 3.0 wt. % calcium oxide, among other impurities. In one embodiment, the SPL 14 contains, on average, about 30.0 wt. % carbon, about 27.3 wt. % sodium fluoride, about 28.6 wt. % aluminum oxide, about 8.4 wt. % silicon dioxide, and about 5.7 wt. % calcium oxide, among other impurities.

In one embodiment, the SPL 14 contains, on average, about 9.1 wt. % aluminum, about 2.4 wt. % calcium, about 24.0 wt. % iron, about 0.1 wt. % potassium, about 0.1 wt. % magnesium, about 2.2 wt. % sodium, about 13.0 wt. % silicon, and about 2.1 wt. % titanium, among other impurities. In some embodiments, the SPL 14 contains aluminum in the range of from about 5.9 wt. % to about 12.7 wt. %, calcium in the range of from about 0.1 wt. % to about 8.1 wt. %, iron in the range of from about 18.0 wt. % to about 32.8 wt. %, potassium in the range of from about 0.0 wt. % to about 0.1 wt. %, magnesium in the range of from about 0.0 wt. % to about 0.1 wt. %, sodium in the range of from about 0.3 wt. % to about 5.9 wt. %, silicon in the range of from about 0.6 wt. % to about 27.2 wt. %, and titanium in the range of from about 0.6 wt. % to about 6.3 wt. %, among other impurities.

As used herein, “bauxite residue” 16 and the like, also known as red mud, means the residue resulting from the production of alumina from bauxite via the Bayer process. In one embodiment, bauxite residue 16 may be any solid impurities or basic solutions resulting from the Bayer process for refining aluminum ore, including iron, titanium, sodium, silica and other impurities resulting from dissolving aluminum oxide with sodium hydroxide, among others. In some embodiments, bauxite residue 16 includes at least one of fine sand, iron oxide, aluminum oxide, aluminum hydroxide, titanium dioxide, calcium oxide, silicon dioxide, sodium hydroxide and sodium oxide, among others. In some instances, bauxite residue 16 may be referred to as red mud or alkaline clay. In some embodiments, bauxite residue 16 may contain various amounts of aluminum oxide, iron oxide, silicon oxide, and titanium oxide, among other components.

In one embodiment, the bauxite residue 16 contains, on average, about 46.0 wt. % iron oxide, about 23.0 wt. % aluminum oxide, about 11.5 wt. % titanium dioxide, about 6.9 wt. % calcium oxide, about 8.0 wt. % silicon dioxide, and about 4.6 wt. % sodium oxide, among other impurities. In one embodiment, the bauxite residue 16 contains, on average, about 38.5 wt. % iron oxide, about 19.3 wt. % aluminum oxide, about 3.9 wt. % titanium dioxide, about 3.8 wt. % calcium oxide, about 31.2 wt. % silicon dioxide, and about 3.3 wt. % sodium oxide, among other impurities.

In some embodiments, the bauxite residues 16 contain iron oxide in the range of from about 29.5 wt. % to about 64.9 wt. %, aluminum oxide in the range of about 15.1 wt. % to about 28.1 wt. %, titanium dioxide in the range of from about 2.5 wt. % to about 6.6 wt. %, calcium oxide in the range of from about 0.4 wt. % to about 7.1 wt. %, silicon dioxide in the range of from about 3.2 wt. % to about 36.7 wt. %, and sodium oxide in the range of from about 1.0 wt. % to about 5.0 wt. %, among other impurities. In some embodiments, the bauxite residues 16 contain aluminum in the range of from about 5.9 wt. % to about 12.7 wt. %, calcium in the range of from about 0.1 wt. % to about 8.1 wt. %, iron in the range of from about 18.0 wt. % to about 32.8 wt. %, potassium in the range of from about 0.0 wt. % to about 0.1 wt. %, magnesium in the range of from about 0.0 wt. % to about 0.1 wt. %, sodium in the range of from about 0.3 wt. % to about 5.9 wt. %, silicon in the range of from about 0.6 wt. % to about 27.2 wt. %, and titanium in the range of from about 0.6 wt. % to about 6.3 wt. %, among other impurities.

As used herein, “cyanide” and the like means any chemical compound that contains the cyano group (C≡N) including the —C≡N radical and the C≡N anion, among others.

As used herein, “fluoride” and the like means any chemical compound that contains fluorine (F). In some instances, fluoride includes the anion F⁻, which is the reduced form of fluorine (F). Examples of fluorides include aluminum fluoride, calcium fluoride, titanium fluoride, sodium fluoride, and iron fluoride, among others.

As used herein, “silicon dioxide” and the like means an oxide of silicon with a chemical formula of SiO₂. Embodiments of silicon dioxide include silica and sand.

As used herein, “vaporized” and the like means to convert into gas or vapor. For example, fluorides may be vaporized during the heating process.

As used herein, “destroyed” and the like means to decompose via thermal oxidation. In some embodiments, cyanide may be destroyed via smelting and not vaporized or released to the environment.

As used herein, “converted” and the like means to change from one form to another. For example, the fluoride within the SPL 14 may be converted to a portion of the byproduct material 24 during the heating process. In another example, the fluoride within the SPL 14 may be converted to a portion of the off-gas 22 during the heating process. In one embodiment, the fluoride in solid form may be converted to gaseous form during the heating step 18. In another embodiment, the fluoride in gaseous form may be reconstituted to sodium or aluminum powders during a cooling process.

As used herein, “non-toxic component” and the like means a substance that is generally not hazardous. For example, non-toxic components are substances that generally do not cause harm to an organism (e.g., humans, animals). In some instances, the non-toxic component is a substance that generally does not contain hazardous materials in sufficient quantities as to be harmful to organisms. In one embodiment, cyanide may be converted to a non-toxic component including the likes of carbon dioxide and nitrogen, among others. In some instances, the thermal destruction of cyanide may result in the creation of carbon dioxide and nitrogen, among others.

In one embodiment, the off-gas 22 may be cooled and concomitant to the cooling step 26, a powder product 28 may be produced. In some embodiments, the powder product 28 includes at least one of metal oxide and metal fluoride. In some instances, the powder product 28 may be recycled back to an aluminum smelter or to an electrolysis cell.

As used herein, “powder product” 28 and the like means condensed particles from the off-gas 22. In one embodiment, the powder product 28 includes condensed forms of metal oxides and/or metal fluorides, among others. Examples of metal oxides include aluminum oxide, calcium oxide, titanium oxide, silicon oxide (and dioxide), sodium oxide, and iron oxide, among others. Examples of metal fluorides include aluminum fluoride, calcium fluoride, titanium fluoride, sodium fluoride, and iron fluoride, among others. In one embodiment, the powder product 28 includes condensed forms of at least one of sodium oxide, aluminum oxide, silicon dioxide, and carbon, among others. In some instances, the powder product 28 may be collected in a bag house and recycled to an aluminum smelter.

In one embodiment, the powder product 28 contains, on average, about 30.1 wt. % sodium fluoride, about 18.6 wt. % sodium oxide, about 33.8 wt. % aluminum oxide, about 0.5 wt. % sodium dioxide, and about 17.0 wt. % carbon, among other impurities. In one embodiment, the powder product 28 contains, on average, about 45.3 wt. % sodium fluoride, about 0.7 wt. % sodium oxide, about 35.3 wt. % aluminum oxide, about 4.4 wt. % sodium dioxide, and about 14.3 wt. % carbon, among other impurities. In one embodiment, the powder product 28 contains, on average, about 30.7 wt. % sodium fluoride, about 0.2 wt. % sodium oxide, about 27.7 wt. % aluminum oxide, about 25.5 wt. % sodium dioxide, and about 15.9 wt. % carbon, among other impurities. In one embodiment, the powder product 28 contains, on average, about 20.1 wt. % sodium fluoride, about 9.3 wt. % sodium oxide, about 21.8 wt. % aluminum oxide, about 32.7 wt. % sodium dioxide, and about 16.0 wt. % carbon, among other impurities.

In one embodiment, concomitant to the cooling step 26, a recyclable gas 30 may be produced. In this embodiment, the recyclable gas 30 includes at least one of carbon monoxide and fluoride gas. In some instances, the recyclable gas 30 may be used as a fuel gas and recycled back to an aluminum smelter or an electrolysis cell.

In one embodiment, prior to the heating step 18, the mixture 12 containing the SPL 14 and the bauxite residue 16 may be mixed. In one example, the mixing involves agglomerating the SPL 14 and the bauxite residue 16 into a cluster.

As used herein, “agglomerating” and the like means to form into a cluster.

As used herein, “cluster” and the like means bringing individual particles substantially close together.

In one embodiment, agglomerating may include mixing a binder 32 with the mixed mixture 12 of SPL 14 and bauxite residue 16. In one example, the binder 32 may be an organic compound. In another example, the binder 32 may be inorganic materials.

As used herein, “binder” 32 and the like means a material used to bind together two or more materials in a mixture. Types of binders 32 include organic compounds and/or inorganic materials. In some embodiments, the organic compounds may be naturally occurring (e.g., sugars, starches) or synthetic (e.g., poly ethylene glycols, lingo-sulfonates, polyvinyl alcohols), among others. Examples of inorganic materials include clay, cement and lime, to name a few.

In one embodiment, prior to the heating step 18, a silicon additive 34 may be added to the mixture 12, which may subsequently be processed according to the steps described above. Concomitant to producing the ferrosilicon alloy 20, the off-gas 22, and/or the byproduct material 24, at least a portion of the silicon additive 34 may be converted into the silicon portion of the ferrosilicon alloy 20. In these instances, the silicon additive 34 includes at least one of silicon oxide and silicon dioxide. In other instances, the silicon additive 34 includes other silicon-containing compounds.

In one embodiment, prior to the heating step 18, a calcium additive 36 may be added to the mixture 12, which may subsequently be processed according to the steps described above. Concomitant to producing the ferrosilicon alloy 20, the off-gas 22, and/or the byproduct material 24, at least a portion of the calcium additive 36 may be converted into a portion of the at least one of the off-gas 22 and the byproduct material 24. In these instances, the calcium additive 36 includes at least one of calcium carbonate, calcium oxide, calcium fluoride and lime. In other instances, the calcium additive 36 includes other calcium-containing compounds.

In one embodiment, a ferrosilicon alloy 20 having at least 10 wt. % silicon may be produced by the following process: (a) heating a mixture 12 comprising SPL 14 and bauxite residue 16, wherein the SPL 14 comprises cyanide, fluoride, carbon and refractory materials, and wherein the bauxite residue 16 comprises iron oxide, aluminum oxide and silicon dioxide. Concomitant to the heating step 18, the ferrosilicon alloy 20 may be produced, wherein the producing step comprises at least one of: (i) converting at least a portion of the silicon dioxide into a silicon portion of the ferrosilicon alloy 20 and (ii) converting at least a portion of the iron oxide into an iron portion of the ferrosilicon alloy 20. The heating may be carried out under similar process conditions as those described above. In some embodiments, the ferrosilicon alloy 20 may contain at least 15 wt. % silicon, or at least 25 wt. % silicon, or at least 45 wt. % silicon, or at least 50 wt. % silicon, or at least 70 wt. % silicon, or at least 75 wt. % silicon, or at least 90 wt. % silicon.

In one embodiment, prior to the heating step 18, a silicon additive 34 may be added to the mixture 12. The mixture 12 may subsequently be subjected to the heating step 18 similar to those discussed above. Concomitant to producing the ferrosilicon alloy 20, at least a portion of the silicon additive may be converted into the silicon portion of the ferrosilicon alloy 20. In another embodiment, prior to the heating step 18, the SPL 14 and the bauxite residue 16 may be be agglomerated into a cluster. In this embodiment, agglomerating comprises mixing a binder 32 with the mixture 12 of SPL 14 and bauxite residue 16. In this instance, the binder 32 may be similar to those described above. The ferrosilicon alloy 20 having at least 10 wt. % silicon may be produced by heating the mixture at a temperature in the range of from about 1500° C. to about 2200° C. and for a period of from about 15 to about 100 minutes. In another embodiment, the mixture 12 may be heated at a temperature of at least about 1500° C.

In one embodiment, a recyclable gas 30 containing carbon monoxide and/or fluoride gas may be produced by heating a mixture 12 comprising SPL 14 and bauxite residue 16. In this embodiment, the SPL 14 comprises cyanide, fluoride, carbon and refractory materials and the bauxite residue 16 comprises iron oxide, aluminum oxide and silicon dioxide. Concomitant to the heating step 18, at least a portion of the fluoride from the SPL 14 may be converted into a portion of an off-gas 22. In this embodiment, the off-gas 22 may be cooled resulting in the production of the recyclable gas 30.

In one embodiment, prior to the heating step 18, the SPL 14 and the bauxite residue 16 may be agglomerated into a cluster, wherein the agglomerating step comprises mixing a binder 32 with the SPL 14 and the bauxite residue 16. In one embodiment, the binder 32 material may be similar to those described above. Like the ferrosilicon alloy 20 having at least 10 wt. % silicon described above, the heating step 18 may occur at a temperature in the range of from about 1500° C. to about 2200° C. and for a period of from about 15 to about 100 minutes. In another embodiment, the mixture 12 may be heated at a temperature of at least about 1500° C.

In one embodiment, a byproduct material 24 containing silicon dioxide and/or aluminum oxide may be produced by heating a mixture 12 containing SPL 14 and bauxite residue 16. In this embodiment, the SPL 14 includes cyanide, fluoride, carbon and refractory materials while the bauxite residue 16 includes iron oxide, aluminum oxide and silicon dioxide. Concomitant to the heating step 18, the byproduct material 24 containing silicon dioxide and/or aluminum oxide may be produced by: (i) converting at least a portion of the fluoride into a first portion of the byproduct material 24; (ii) converting at least a portion of the silicon dioxide into a second portion of byproduct material 24; and (iii) converting at least a portion of the iron oxide into a third portion of the byproduct material 24.

In one embodiment, prior to the heating step 18, the SPL 14 and the bauxite residue 16 may be agglomerated into a cluster, wherein the agglomerating step comprises mixing a binder 32 with the SPL 14 and the bauxite residue 16. In one embodiment, the binder 32 material may be similar to those described above. Like the products and processes described above, the heating step 18 may be carried out at a temperature in the range of from about 1500° C. to about 2200° C. and for a period of from about 15 to about 100 minutes. In another embodiment, the mixture 12 may be heated at a temperature of at least about 1500° C.

### EXAMPLES

### All Values are Approximate Weights and Weight Percentages

Bauxite Residue Reduction with Spent Pot Lining (SPL) @ 1800° C.

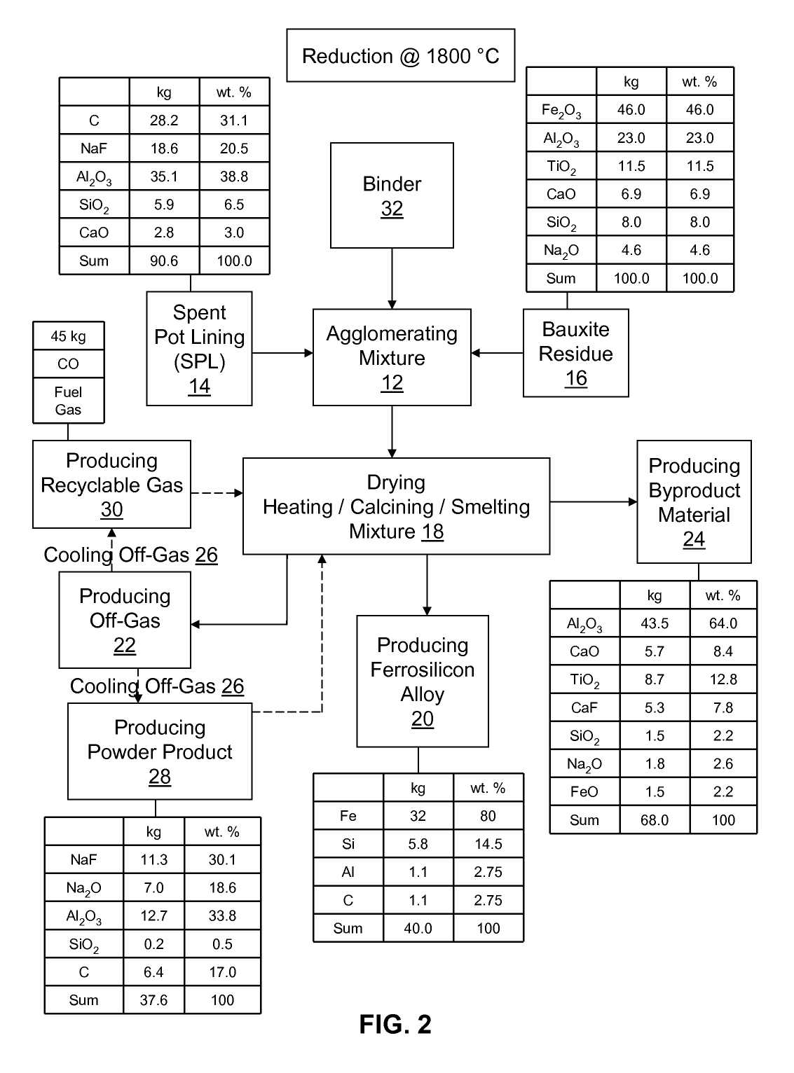

FIG. 2 is a block diagram illustrating a process flow of treating SPL 14 and bauxite residue 16 with a binder 32 according to one embodiment of the present disclosure. Specifically, about 90.6 kg of SPL 14 can be reacted with about 100.0 kg of bauxite residue 16. The chemical compositions for each reactant are listed in adjacent tables as shown in the figure. For instance, the approximately 90.6 kg of SPL 14 contains about 28.2 kg carbon, about 18.6 kg sodium fluoride, about 35.1 kg aluminum oxide, about 5.9 kg silicon dioxide, and about 2.8 kg calcium oxide. The agglomerated mixture 12 is heated at a temperature of about 1800° C. The heating step 18 results in the production of about 40.0 kg ferrosilicon alloy 20, an off-gas 22, and a byproduct material 24 of about 68.0 kg. The approximately 68.0 kg of byproduct material 24 contains about 43.5 kg aluminum oxide, about 5.7 kg calcium oxide, about 8.7 kg titanium oxide, about 5.3 kg calcium fluoride, about 1.5 kg silicon dioxide, about 1.8 kg sodium oxide, and about 1.5 kg iron oxide. The off-gas 22 may subsequently be cooled to produce a recyclable gas 30 of about 45 kg and a powder product 28 of about 37.6 kg. In this case, the recyclable gas 30 consists of carbon monoxide, which may be returned to the heating step 18 as a fuel gas.

Bauxite Residue Average Reduction with SPL @ 1750° C.

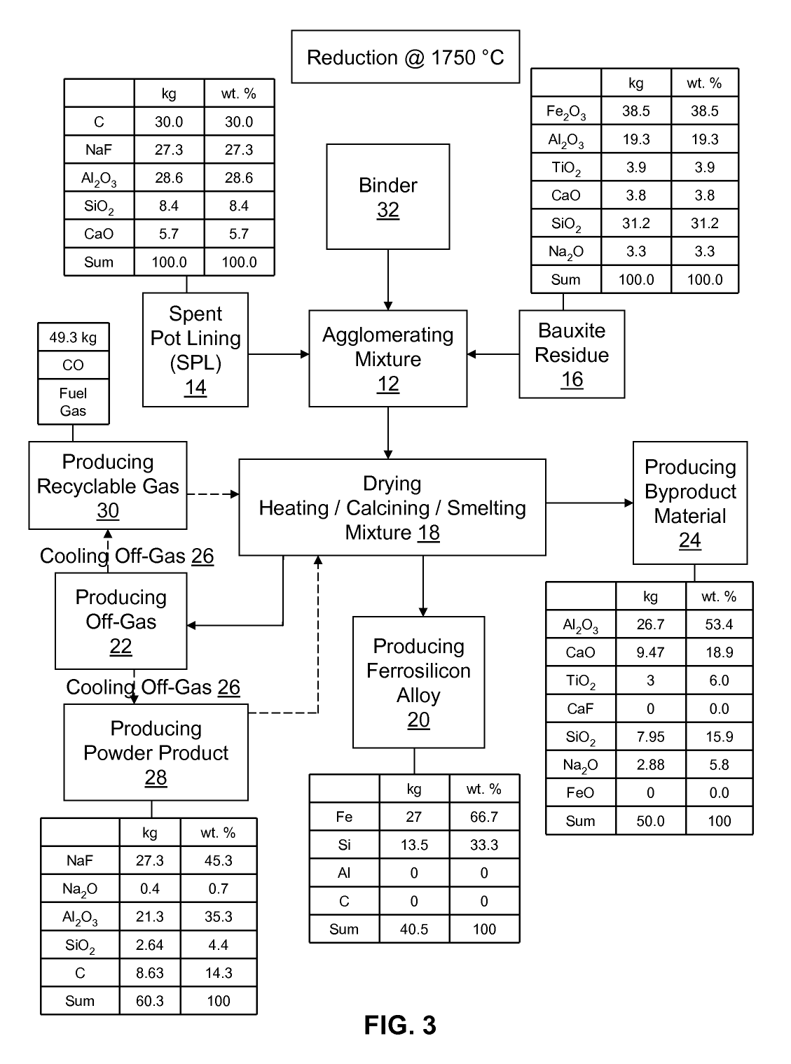

FIG. 3 is a block diagram illustrating a process flow of treating SPL 14 and bauxite residue (average) 16 with the a binder 32 according to one embodiment of the present disclosure. In this example, about 100.0 kg of SPL 14 can be reacted with about 100.0 kg of bauxite residue (average) 16. The 100.0 kg of bauxite residue (average) 16 contains about 38.5 kg iron oxide, about 19.3 kg aluminum oxide, about 3.9 kg titanium oxide, about 3.8 kg calcium oxide, about 31.2 kg silicon dioxide, and about 3.3 kg sodium oxide. The agglomerated mixture 12 is heated at a temperature of about 1750° C. The heating step 18 results in the production of a ferrosilicon alloy 20 of about 40.5 kg, an off-gas 22, and a byproduct material 24 of about 50.0 kg. The ferrosilicon alloy 20 contains about 33.3 wt. % silicon and about 66.7 wt. % iron. The off-gas 22 can be cooled to produce a carbon monoxide fuel gas 30 of about 49.3 kg and a powder product 28 of about 60.3 kg.

Bauxite Residue Average Reduction with SPL and SiO_{2 @ 1750}° C.

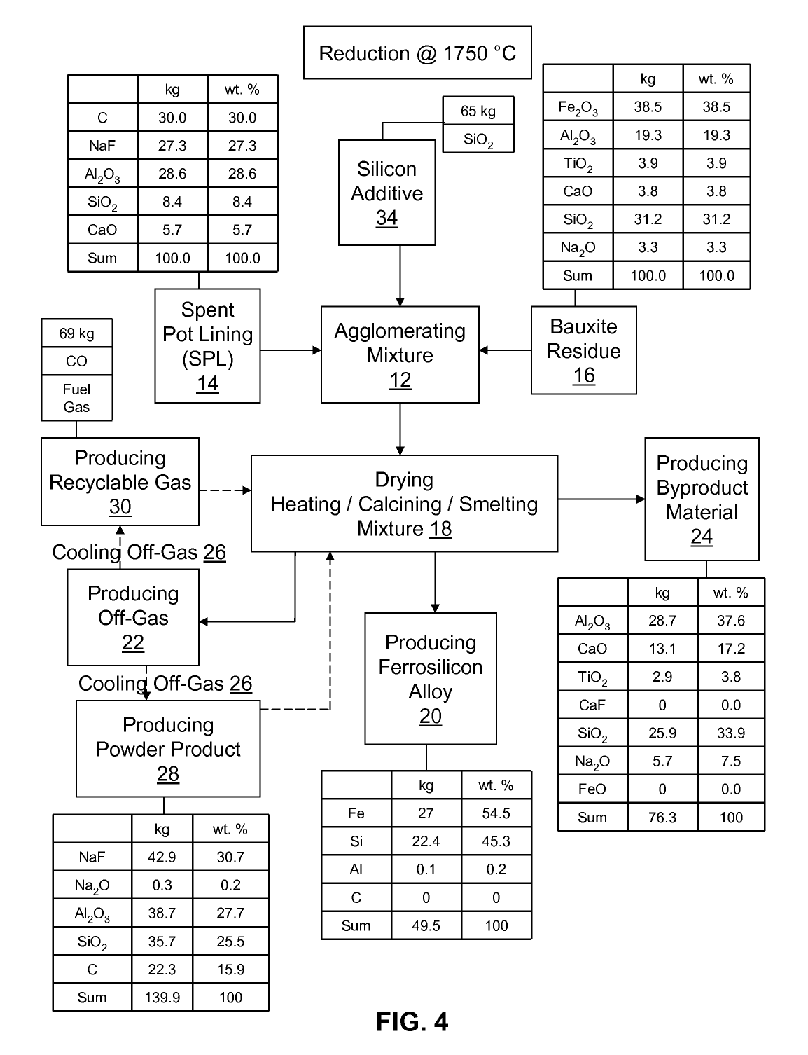

FIG. 4 is a block diagram illustrating a process flow of treating SPL 14 and bauxite residue (average) 16 with a silicon additive 34 such as silicon dioxide according to one embodiment of the present disclosure. In this example, about 100.0 kg of SPL 14 can be reacted with about 100.0 kg of bauxite residue (average) 16 and about 65 kg of SiO₂. The agglomerated mixture 12 can be heated at a temperature of about 1750° C. The heating step 18 results in the production of a ferrosilicon alloy 20 weighing about 49.5 kg, an off-gas 22, and a byproduct material 24 weighing about 76.3 kg. The ferrosilicon alloy 20 contains about 54.5 wt. % silicon and about 45.3 wt. % iron with minor aluminum contribution (e.g., about 0.2 wt. %). The off-gas 22 can be cooled to produce a carbon monoxide fuel gas 30 weighing about 69 kg and a powder product 28 weighing about 139.9 kg. In this instance, the approximately 139.9 kg powdered product 28 contains about 42.9 kg sodium fluoride, about 0.3 kg sodium oxide, about 38.7 kg aluminum oxide, about 35.7 kg silicon dioxide, and about 22.3 kg carbon.

Bauxite Residue Average Reduction with SPL and SiO₂ and CaCO_{3 @ 1750}° C.

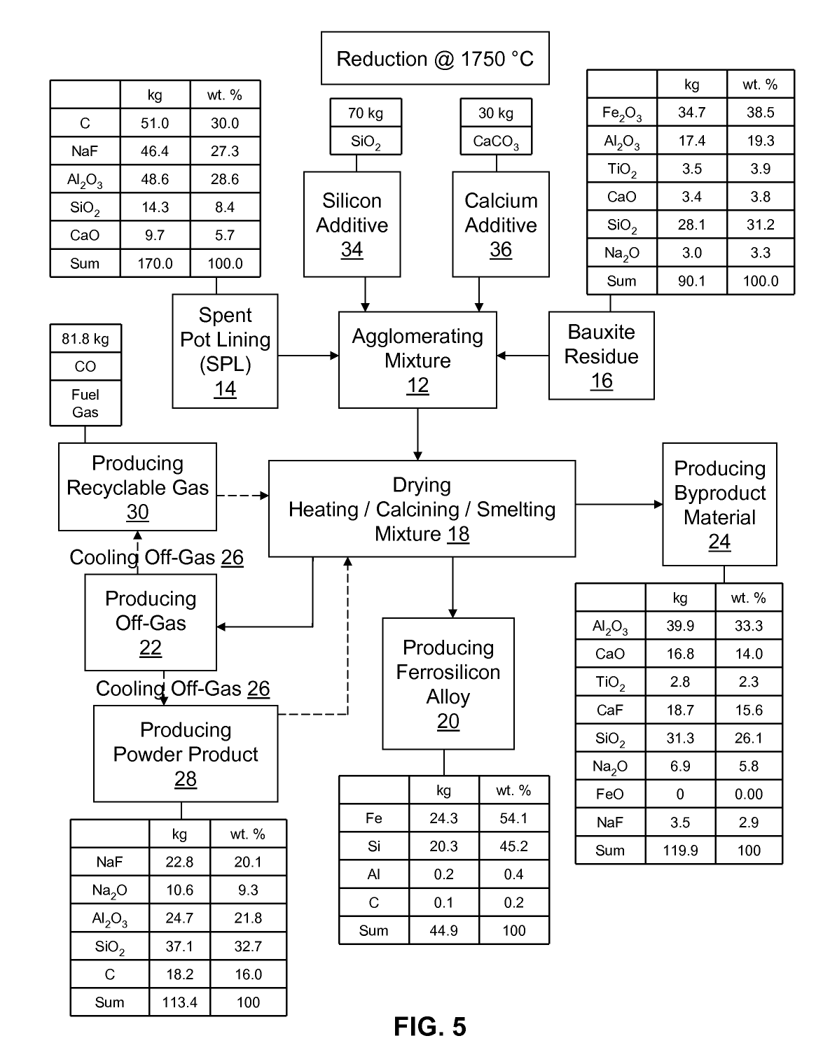

FIG. 5 is a block diagram illustrating a process flow of treating SPL 14 and bauxite residue (average) 16 with silicon dioxide 34 and calcium carbonate 36 according to one embodiment of the present disclosure. In this example, about 170.0 kg of SPL 14 can be reacted with about 90.1 kg of bauxite residue (average) 16, and about 70 kg of SiO₂ and 30 kg of CaCO₃. The agglomerated mixture 12 can be heated at a temperature of about 1750° C. The heating step 18 results in the production of a ferrosilicon alloy 20 weighing about 44.9 kg, an off-gas 22, and a byproduct material 24 weighing about 119.9 kg. The off-gas 22 can be cooled to produce a carbon monoxide fuel gas 30 weighing about 81.8 kg and a powder product 28 weighing about 113.4 kg. The ferrosilicon alloy 20 contains about 54.1 wt. % silicon and about 45.2 wt. % iron with minor aluminum and carbon contributions (e.g., about 0.4 wt. % and about 0.2 wt. %, respectively). In this instance, the approximately 119.9 kg byproduct material 24 contains about 39.9 kg aluminum oxide, about 16.8 kg calcium oxide, about 2.8 kg titanium oxide, about 18.7 kg calcium fluoride, about 31.3 kg silicon dioxide, about 6.9 kg sodium oxide, about 0 kg iron oxide, and about 3.5 kg sodium fluoride.

Although the disclosure has been described in detail with reference to several embodiments, additional variations and modifications exist within the scope and spirit of the disclosure as described and defined in the following claims.

What is claimed is:

1. A method comprising:
(a) producing a mixture, wherein the mixture comprises spent pot lining and bauxite residue;
(b) heating the mixture at a temperature of at least about 1500° C.; and
(c) producing at least one of a ferrosilicon alloy, an off-gas, and a byproduct material from the mixture and due, at least in part, to the heating step.

2. The method of claim 1, wherein the spent pot lining comprises cyanide and fluoride, and wherein the bauxite residue comprises iron oxide and silicon dioxide.

3. The method of claim 2, comprising:
(i) converting at least a portion of the cyanide into a non-toxic component; and
(ii) vaporizing at least a portion of the fluoride.

4. The method of claim 2, comprising:
(i) converting at least a portion of the silicon dioxide into a silicon portion of the ferrosilicon alloy;
(ii) converting at least a portion of the iron oxide into an iron portion of the ferrosilicon alloy; and
(iii) converting at least a portion of the fluoride into a portion of the at least one of the off-gas and the byproduct material.

5. The method of claim 1, further comprising:
(c) cooling the off-gas; and
(d) producing, concomitant to the cooling step, a powder product, wherein the powder product comprises at least one of metal oxide and metal fluoride.

6. The method of claim 5, further comprising:
(e) recycling the powder product to an aluminum smelter.

7. The method of claim 5, further comprising:
(e) producing, concomitant to the cooling step, a recyclable gas, wherein the recyclable gas comprises at least one of carbon monoxide and fluoride gas.

8. The method of claim 1, wherein the mixture further comprises a silicon additive, and wherein the method comprises, concomitant to the heating step, converting at least a portion of the silicon additive into a silicon portion of the ferrosilicon alloy.

9. The method of claim 1, wherein the mixture further comprises a calcium additive, and wherein the method comprises, concomitant to the heating step, converting at least a portion of the calcium additive into a portion of the at least one of the off-gas and the byproduct material.

10. A ferrosilicon alloy having at least 10 wt. % silicon, wherein the ferrosilicon alloy is produced by the following process:
(a) heating a mixture comprising spent pot lining and bauxite residue, wherein the bauxite residue comprises iron oxide and silicon dioxide; and
(b) concomitant to the heating step, producing the ferrosilicon alloy, wherein the producing step comprises at least one of:
(i) converting at least a portion of the silicon dioxide into a silicon portion of the ferrosilicon alloy; and
(ii) converting at least a portion of the iron oxide into an iron portion of the ferrosilicon alloy.

11. The ferrosilicon alloy of claim 10, wherein the mixture further comprises a silicon additive, and wherein at least a portion of the silicon additive is converted into a silicon portion of the ferrosilicon alloy and due, at least in part, to the heating step.

12. The ferrosilicon alloy of claim 10, wherein the heating step comprises heating the mixture at a temperature of at least about 1500° C.

13. A recyclable gas having at least one of carbon monoxide and fluoride gas, wherein the recyclable gas is produced by the following process:
(a) heating a mixture comprising spent pot lining and bauxite residue, wherein the spent pot lining comprises fluoride;
(b) concomitant to the heating step, converting at least a portion of the fluoride into a portion of an off-gas; and
(c) cooling the off-gas.

14. The recyclable gas of claim 13, wherein the heating step comprises heating the mixture at a temperature of at least about 1500° C.

15. A byproduct material comprising at least one of silicon dioxide and aluminum oxide, wherein the byproduct material is produced by the following process:
(a) heating a mixture comprising spent pot lining and bauxite residue, wherein the spent pot lining comprises fluoride and wherein the bauxite residue comprises iron oxide and silicon dioxide; and
(b) concomitant to the heating step, producing the byproduct material, wherein the producing step (b) comprises at least one of:
(i) converting at least a portion of the fluoride into a first portion of the byproduct material;
(ii) converting at least a portion of the silicon dioxide into a second portion of byproduct material; and
(iii) converting at least a portion of the iron oxide into a third portion of the byproduct material.

16. The byproduct material of claim 15, wherein the heating step comprises heating the mixture at a temperature of at least about 1500° C.
